(19) United States
(12) Patent Application Publication
(10) Pub. No.: US 2007/0288245 A1
(43) Pub. Date: Dec. 13, 2007

(54) Charisma monetization through an integrated and reusable commerce engine

(75) Inventor: Yobie Benjamin, Fremont, CA (US)

Correspondence Address: RAJ ABHYANKER, LLP;c/o PORTFOLIOIP, P.O. BOX 52050, MINNEAPOLIS, MN, 55402, US

(73) Assignee: Society Cafe, Inc.

(21) Appl. No.: 11/448,219

(22) Filed: Jun. 7, 2006

(51) Int. Cl. G06Q 10/00; G06Q 30/00

(52) U.S. Cl. 705/1

(57) ABSTRACT

Charisma monetization through an integrated and reusable commerce engine is disclosed. In one embodiment, a method of a service provider includes providing a holistic commerce solution to an admired party through an integration of a branded commerce engine in a mark-up language page of the admired party, fulfilling a transaction when a follower of the admired party purchases an offering on the mark-up language page based on a charismatic influence of the admired party on the follower, and sharing a portion of a profit generated from the transaction with the admired party. The admired party may purchase the offering on the mark-up language page at a premium to a market value of the offering based on an empathy relationship between the follower and the admired party formed through a charismatic influence of the admired party on the follower. The method may automatically populate the mark-up language page of the admired party with at least one offering representing a value of the admired party when the admired party integrates the branded commerce engine in the mark-up language page.

### FIELD OF TECHNOLOGY

This disclosure relates generally to the technical fields of computer technology and, in one example embodiment, to a charisma monetization through an integrated and reusable commerce engine.

### BACKGROUND

An admired party (e.g., a charismatic personality, a political figure, a social figure, a religious figure, a non-profit entity, a cultural figure, a professional figure, an admired entity, etc.) may share information (e.g., personal beliefs, religious beliefs, controversial information, cultural information, professional advice, opinions, etc.) on the Internet through a variety of mechanisms (e.g., through a blog, a web page, a discussion forum, etc.). The admired party may build a following (e.g., believers, fans, patrons, etc.) based on content published electronically (e.g., through an electronic billboard, a website, a kiosk, etc.). The admired party may spend a lot of resources (e.g., time, energy and/or money) in maintaining and/or up-keeping of published electronic content (e.g., maintaining the website).

The admired party may allow a prominent search engine (e.g., Google®, YAHOO!®, etc.) to place links on its website. The admired party and/or the follower may find these links annoying and/or disturbing (e.g., links may cause cluttering, distraction, dilute the content of the web page, and/or refer out to other sites). A revenue may be tied to a small link-referral to an advertiser site (e.g., a click-through) when the follower is referred to the advertiser site through the links. However, the admired party may not have the time, the disposition, the resources, and/or the skills (e.g., accounting skills, business skills, marketing skills, supply management, etc.) to operate and/or conduct e-commerce.

### SUMMARY

Charisma monetization through an integrated and reusable commerce engine is disclosed. In one aspect, a method of a service provider includes providing a holistic commerce solution to an admired party through an integration of a branded commerce engine in a mark-up language page of the admired party, fulfilling a transaction when a follower of the admired party purchases an offering on the mark-up language page based on a charismatic influence of the admired party on the follower, and sharing a portion of a profit generated from the transaction with the admired party. The follower may purchase the offering on the mark-up language page at a premium to a market value of the offering based on an empathy relationship between the follower and the admired party formed through the charismatic influence of the admired party on the follower.

The method may automatically populate the mark-up language page of the admired party with at least one offering representing a value of the admired party when the admired party integrates the branded commerce engine in the mark-up language page. The at least one offering of the admired party may be determined from a virtual inventory based on a value parameter specified by the admired party. The value parameter may be based a personal value, a political value, a religious value, a professional value, a social value and/or a controversial value.

At least one offering on the mark-up language page of the admired party may be refreshed based on a change in the value parameter specified by the admired party. The follower of the admired party may be enabled to perform a transaction in its entirety without leaving a particular mark-up language page when the transaction is initiated through a stripping a browser embodying the mark-up language page of header fields and disguising the browser as a frame embedded directly in the mark-up language page as a session-less pop-in to the mark-up language page.

The fulfillment of the transaction may be based on a drop-ship of the offering to the follower arranged through a network of distributors associated with the service provider when the follower purchases an offering on the mark-up language page of the admired party. The offering may be at least one of a physical media, a digital media and a service.

In another aspect, a method of an admired party includes integrating a branded commerce engine provided by a third party such that a module associated with the admired party includes an offering representing a value of the admired party, monetizing the offering through the third party that facilitates a drop-ship of the offering to a follower that purchases the offering through the branded commerce engine at a price based on an empathy relationship between the follower and the value of the admired party, and automatically receiving a share of a profit associated with the monetizing of the offering.

The method may include accessing a management module to control the offering presented on the mark-up language page of the admired party through the branded commerce engine provided by the third party. In addition, a redeemable coupon may be generated that is associated with a service provider to a political campaign to encourage support by the follower to a candidacy of the admired party to a government office. The price associated with the monetizing the offering may be at a premium to a market price of a comparable offering through a goodwill relationship formed between the follower and the admired party over a series of communications of the admired party made accessible to the follower through a web log structure.

In yet another aspect, a system may include an admired party to integrate an adaptable commerce engine in a mark-up language page that monetizes a charisma of the admired party with a plurality of followers through a promotion of a branded offering on the mark-up language page, a profit sharing module to allocate a portion of a profit to the admired party, and a fulfillment module to conduct an end-to-end purchase to sale of the branded offering on behalf of the admired party. The admired party may primarily provide a content-based information independent of monetizing a brand identity of the admired party.

A growth of the brand identity may be a result of a popularity of the content-based information in a geographic region. The profit sharing module may provide a transparent financial visibility to the admired party of a wholesale purchase of the branded offering to the retail sale of the branded offering to the plurality of followers. The adaptable commerce engine may be masked through a mark-up language technique such that an identity of an entity having the profit sharing module and the fulfillment module is not visible to the plurality of followers.

The entity may provide a service through a drop-ship from a distributor. The entity may stock no inventory of the branded offering. An i-frame technique may be used to mask an identity of the adaptable commerce engine. The adaptable commerce engine may enable the admired party to customize a selection of the branded offering through a promotional selection tool associated with the entity. The branded offering may be rotated along with other branded offerings on the mark-up language page. The branded offering may be an apparel offering, a digital music offering, and/or a political message memorabilia offering.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a network of admired parties each having an integrated reusable commerce engine provided through a charisma monetization module supported through a network of offering distributors, according to one embodiment.

FIG. 2 is an exploded view of the service provider module of FIG. 1, according to one embodiment.

FIG. 3 is an exploded view of the admired party module of FIG. 1, according to one embodiment.

FIG. 4 is a table view of content referenced by the profile database of FIG. 2, according to one embodiment.

FIG. 5 is a user interface view of the mark-up language page of FIG. 3 associated with the admired party module of FIG. 1, according to one embodiment.

FIG. 6 is a user interface view of the service provider module of FIG. 1, according to one embodiment.

FIG. 7 is a diagrammatic representation of a data processing system capable of processing a set of instructions to perform any one or more of the methodologies herein, according to one embodiment.

FIG. 8 is an interaction diagram of a process flow between the service provider module, the admired party module and the follower device of FIG. 1, according to one embodiment.

FIG. 9 is a process flow to provide a holistic commerce solution to an admired party, according to one embodiment.

FIG. 10 is a process flow to integrate a branded commerce engine provided by a third party, according to one embodiment.

Other features of the present embodiments will be apparent from the accompanying drawings and from the detailed description that follows.

### DETAILED DESCRIPTION

Charisma monetization through an integrated and reusable commerce engine is disclosed. In the following description, for the purposes of explanation, numerous specific details are set forth in order to provide a thorough understanding of the various embodiments. It will be evident, however to the one skilled in the art that the various embodiments may be practiced without these specific details.

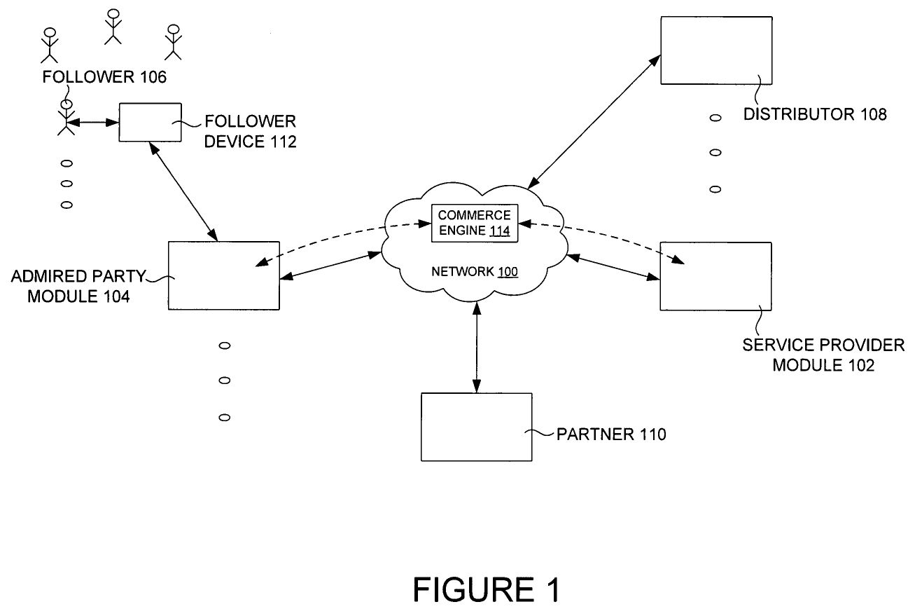

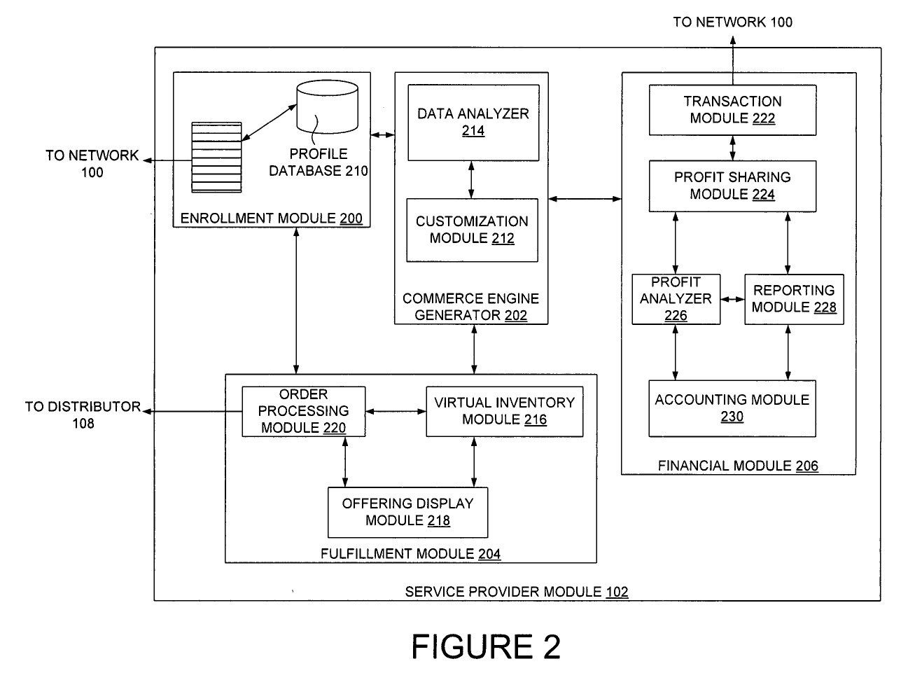

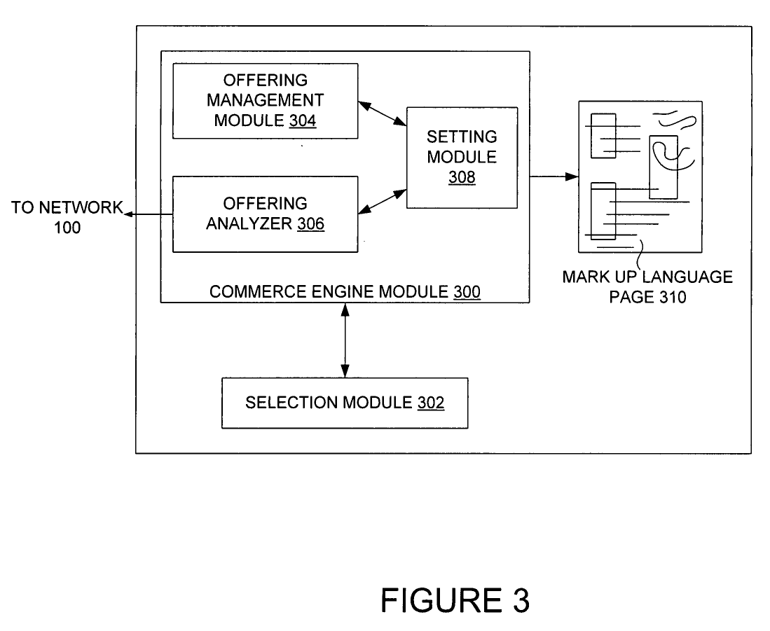

In one embodiment, a method of a service provider includes providing a holistic commerce solution to an admired party (e.g., using a service provider module 102) through an integration of a branded commerce engine in a mark-up language page (e.g., the mark-up language page 310 of FIG. 3) of the admired party (e.g., associated with the admired party module 104 of FIG. 1b), fulfilling a transaction when a follower of the admired party purchases an offering on the mark-up language page based on a charismatic influence (e.g., a charismatic influence may be an influence and/or value of the admired party that evokes a partiality, a resonance, an empathy, an affinity, a recognition, and/or an appreciation, etc. from the follower such as the follower 106 of FIG. 1) of the admired party on the follower (e.g., using the fulfillment module 204 of FIG. 2), and sharing a portion of a profit generated from the transaction with the admired party (e.g., through the profit sharing module 224 of FIG. 2).

In another embodiment, a method of an admired party includes integrating a branded commerce engine (e.g., the commerce engine 114 illustrated in FIG. 2 provided by a third party such that a module associated with the admired party (e.g., the admired party module 104) includes an offering (e.g., a branded offering, a service, a digital media offering, a physical offering, etc.) representing a value (e.g., a political value, a social value, a personal value, a religious value, a controversial value, etc.) of the admired party, monetizing the offering through the third party that facilitates a drop-ship of the offering (e.g., the distributor 108 illustrated in FIG. 1) to a follower (e.g., the follower 106 of FIG. 1) that purchases the offering through the branded commerce engine at a price based on an empathy relationship between the follower and the value of the admired party, and automatically receiving a share of a profit associated with the monetizing of the offering.

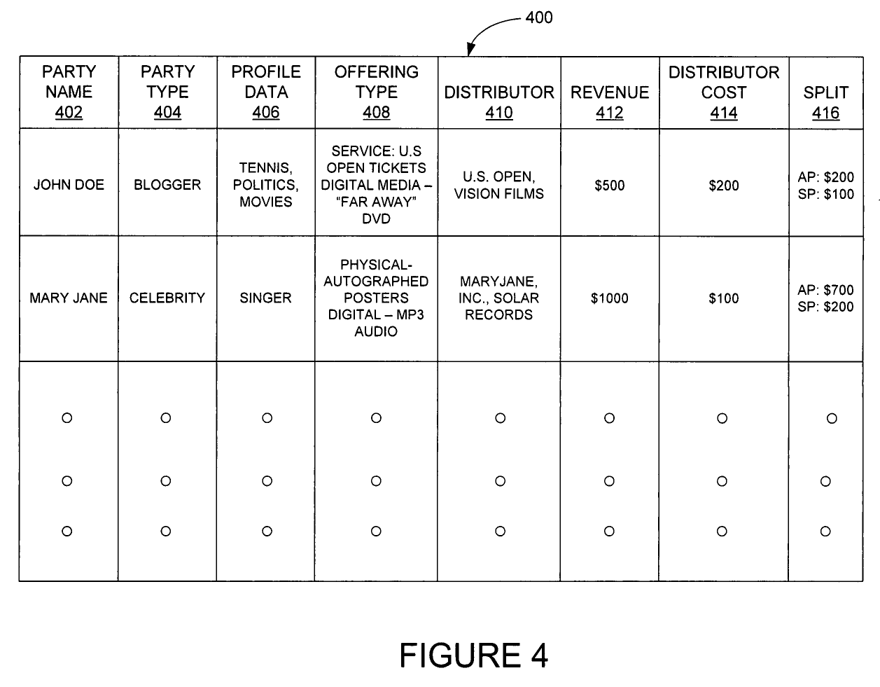

In yet another embodiment, a system may include an admired party to integrate an adaptable commerce engine in a mark-up language page (e.g., the mark-up language page 310) that monetizes a charisma (e.g., using the service provider module 102)of the admired party with a plurality of followers (e.g., the follower 106) through a promotion of a branded offering on the mark-up language page (e.g., a virtual inventory), a profit sharing module (e.g., the profit sharing module 224) to allocate a portion of a profit to the admired party (e.g., as illustrated in the table view 400 of FIG. 4), and a fulfillment module (e.g., the fulfillment module 204) to conduct an end-to-end purchase to sale of the branded offering on behalf of the admired party.

It will be appreciated that the various embodiments discussed herein may/may not be the same embodiment, and may be grouped into various other embodiments not explicitly disclosed herein.

FIG. 1 is a system view of a network of admired parties, having a service provider module 102, an admired party module 104, a follower 106, a distributor 108, a partner 110, a follower device 112, and a commerce engine 114, which may communicate through a network 100 (e.g., internet). The service provider module 102 may provide a holistic commerce solution (e.g., a charisma monetization solution) to an admired party (e.g., associated with the admired party module 104) through an integration of an integrated, reusable and/or branded commerce engine (e.g., the commerce engine 114 may be provided by the service provider module 102) in a mark-up language page (e.g., a website, a blog, etc.) of the admired party.

The admired party may be any party (e.g., a person, a persona, a representative of a non-human entity) having a social, religious, political, virtual, personal etc. significance (e.g., a blogger, a celebrity, an artiste, a friend of another party, etc.) to another party (e.g., the follower 106). The follower 106 (e.g., a fan, a friend, a patron, a supporter etc. of the admired party associated with the admired party module 104) may communicate with the admired party module 104 (e.g., may visit a website of the admired party) through the follower device 112 (e.g., a desktop computer, a laptop, a PDA, a telecommunications device, etc.) to engage in a transaction (e.g., to purchase branded offerings, based on an empathy with and/or a charisma of, the admired party) through the mark up language portal associated with the admired party module 104.

For example, the branded offerings may be digital media offerings (e.g, digital music), physical offerings (e.g., apparel) and/or services (e.g., tickets, political message memorabilia, etc.). The transaction initiated by the follower 106 through the mark up language portal (e.g., using the commerce engine 114 associated with the admired party module 104 and/or provided by the service provider module 102) of the admired party may be at a price based on an empathy relationship between the follower 106 and the value (e.g., the interests, the cause, etc.) of the admired party. The transaction may be fulfilled based on a drop-ship (e.g., shipping to order) of the offerings to the follower 106, arranged through a network of distributors (e.g., such as the distributor 108 illustrated in FIG. 1) associated with the service provider module 102 (e.g., the service provider module 102 may maintain no inventory of the branded offerings) when the follower 106 purchases an offering on the mark-up language page of the admired party (e.g., and/or generated using the admired party module 104).

For example, the admired party may be a celebrity and/or a blogger (e.g., a web logger) who primarily provides a content-based information (e.g., on his/her website) without profiting from his/her popularity (e.g., independent of monetizing a brand identity associated with the admired party module 104). A growth of the brand identity (e.g., of the admired party) may be a result of a popularity of the content-based information in a geographic region.

The partner 110 may be a strategic, business and/or service partner (e.g., a social network provider, a relationship network, etc.) associated with the service provider module 102. For example, the partner 110 may be a friendship network of users having profiles listed on mark-up language pages in which the service provider module 102 may integrate commerce engines (e.g., the commerce engine 114 illustrated in FIG. 1) based on preferences set by the users (e.g., the users may be admired parties of other users) and/or the partner 110.

The commerce engine 114 may be a branded commerce engine (e.g., a program script, a code, a plug-in, a utility, etc.) integrated into the mark-up language page of the admired entity. The commerce engine 114 may provide the follower 106 of the admired party module 104 a complete process for selecting, reviewing and/or purchasing the branded offerings promoted on the mark-up language page of the admired party.

FIG. 2 is an exploded view of the service provider module 102 of FIG. 1, having an enrollment module 200, a commerce engine generator module 202, a fulfillment module 204 and/or a financial module 206, according to one embodiment. The enrollment module 200 may include an enrollment form 208 and/or a profile database 210. The commerce engine generator module 202 may include a customization module 212 and/or a data analyzer 214.

The fulfillment module 204 may include a virtual inventory module 216, an offering display module 218 and/or an order processing module 220. The financial module 206 may include a transaction module 222, a profit sharing module 224, a profit analyzer 226, a reporting module 228 and/or an accounting module 230. The enrollment module 200 may process (e.g., capture, generate, record, track, store, manage, etc.) an enrollment (e.g., an online signup) of the admired party (e.g., the admired party associated with the admired party module 104 of FIG. 1) with the service provider module 102 based on a profile of values (e.g., interests) of the admired party.

For example, the enrollment module 200 may process a value parameter specified by the admired party (e.g., based on a personal value, a political value, a religious value, a professional value, a social value and/or a controversial value, etc.) through the enrollment form 208 (e.g., a template of choices) communicated to the admired party (e.g., through the admired party module 104).

The value parameters associated with various admired party modules may be referenced (e.g., recorded, stored, tracked, etc.) by the profile database 210. The commerce engine generator module 202 may determine (e.g., generate, calculate, etc. using various algorithms, mapping processes and/or predefined settings, etc.) a customized commerce engine (e.g., the commerce engine 114 of FIG. 1) for the mark up language portal associated with the admired party module 104, through the customization module 212 and/or based on a communication with the enrollment module 200.

The customization module 212 may refresh the at least one offering on the mark-up language page of the admired party based on a change in the value parameter specified by the admired party (e.g., using the enrollment form 208). For example, the data analyzer 214 may communicate with the customization module 212 and/or the admired party module 104 to process (e.g., analyze, track, capture, etc.) the value parameters (e.g., the profile) communicated by the admired party module 104 to the enrollment module 200, and/or to process (e.g., facilitate) a synchronization (e.g., a modification, an update, a refreshing) of the customization module 212 and/or the enrollment module 200.

The fulfillment module 204 may process an end-to-end purchase to sale of the branded offering on behalf of the admired party associated with the admired party module 104. The virtual inventory module 216 may process (e.g., create, render, etc.) a virtual inventory (e.g., a stock of branded offerings visible in an online environment but not carried as physical inventory by the admired party module 104 or the service provider module 102) customized to the value parameter(s) of the admired party on the mark-up language page of the admired party (e.g., the branded offerings in the virtual inventory may be available for purchase to the follower 106 of the admired party using the commerce engine 114 integrated into the mark-up language page associated with the admired party module 104.

The offering display module 218 may process data and/or meta data associated with the display (e.g., through a graphical user interface) of the virtual inventory on the mark-up language page of the admired party module 104. In one embodiment, the offering display module 218 may enable the follower 106 of the admired party to perform a transaction (e.g., purchase branded offering using the integrated commerce engine of the admired party module 104) in its entirety without leaving a particular mark-up language page (e.g., website) when the transaction is initiated.

For example, the offering display module 218 may strip a web browser embodying the mark-up language page of header fields and disguise the browser as a frame embedded directly in the mark-up language page as a session-less pop-in to the mark-up language page (e.g., the follower 106 using the mark-up language page may perceive the transaction as taking place seamlessly in the same browser window). The follower 106 may be able to perform the entire transaction through a single click of a pointing device (e.g., a mouse) through an iframe technology (e.g., by embedding a document within another document) whereby the follower may be able to view and/or provide information (e.g., detailed product specification, buyer information, credit card information, shipping and/or handling information, etc.) in a single browser window embedded in the mark-up language page, without leaving the mark-up language page of the admired party module 104. The single browser window may have multiple panes (e.g., shipping information pane, credit card information pane etc.) that may have drop down form(s) that the follower may activate (e.g., by selection) and fill information (e.g., shipping information, credit card information, etc.).

In another embodiment, the offering display module 218 may mask the identification (e.g., universal resource locator) of the service provider module 102 such that the entity associated with the service provider module 102 is not visible to the follower 106 engaged in the transaction. The offering display module 218 may also remember settings (e.g., personal information, credit card information, etc.) to allow the follower 106 to execute a transaction without entering any information (e.g., by just clicking the ‘buy’ button).

In yet another embodiment, the offering display module 218 may rotate the branded offering along with other branded offerings on the mark-up language page of the admired party module 104 (e.g., based on predefined settings, based on the admired party's preferences, based on a customization of the virtual inventory, based on a temporal marker, etc.). The offering display module 218 may also optimize the mark-up language page of the admired party module 104 for a single offering (e.g., a single sku personalized based on the content and/or the interests of the admired party associated to the mark-up language page) to allow the follower 106 to instantly purchase the single offering (e.g., based on an impulse-buy of the follower) through a single click purchase mechanism (e.g., by using the iframe technology). The display of the offering (e.g., the single sku) may also be optimized so as to preserve subtleness of the mark-up language page (e.g., maintain identity of a web page) so that the follower 106 and/or the admired party module 104 may not find the offerings and/or the mark-up language page obtrusive (e.g., a shopping website).

The order processing module 220 may communicate with the admired party module 104, the follower device 112 and/or distributors 108 to process (e.g., capture, record, track, communicate, etc.) an order (e.g., a selection of branded offerings, a virtual shopping cart, etc. to be purchased by the follower 106 through the commerce engine 114 of the admired party module 104). For example, the order processing module 220 may communicate with the distributor 108 associated with the branded offerings selected by the follower 106 to synchronize a drop-shipping of the offerings to the follower 106 by the distributor 108. The entire fulfillment process may be fully integrated within the branded commerce engine and may not require external shopping applications (e.g., shopping carts, 3^{rd} party catalogues, etc) and/or web service interface (e.g., 3^{rd} party application programming interface).

The transaction module 222 may process (e.g., capture, track, record, communicate, store, monitor, analyze, etc.) financial data and/or meta data associated with the transaction initiated by the follower 106 through the commerce engine 114 of the admired party module 104. The transaction module 222 may process financial preferences and/or information associated with the follower 106 who purchases the offering(s) through the commerce engine 114 to monetize the promotion of the branded offering through the admired party module 104.

For example, the price (e.g., of the offering, and/or to the follower 106) associated with the monetizing of the offering is at a premium (e.g., is higher) to a market price of a comparable offering through a goodwill relationship formed between the follower and the admired party over a series of communications of the admired party made accessible to the follower through a web log structure (e.g., the follower 106 may be a fan of the admired party's blog).

In another embodiment, the price may be at a premium to a market value of the offering based on an empathy relationship between the follower 106 and the admired party formed through the charismatic influence of the admired party on the follower 106, and/or based on an empathy relationship between the follower 106 and the value(s) of the admired party (e.g., the value(s) may be known and/or perceived by the follower 106).

The profit sharing module 224 may process (e.g., determine, calculate, etc.) shares (e.g., splits, distributions, allotments, etc.) of a profit (e.g., derived from a revenue) generated through the purchase of the offering by the follower 106 (e.g., the payment processed of the follower 106 may be communicated by the commerce engine 114 of the admired party module 104 to the service provider module 102).

In one embodiment, the profit sharing module 224 may provide a portion of the profit to the admired party associated with the admired party module 104. The profit sharing module 224 may determine (e.g., analyze, calculate, compute, etc.) the portion of the profit using the profit analyzer 226. For example, the profit sharing module 224 may provide a transparent financial visibility to the admired party of a wholesale purchase of the branded offering (e.g., by the service provider module 102, based on information submitted in the enrollment form 208 by the admired party, and/or from the distributor 108 illustrated in FIG. 1) to the retail sale of the branded offering (e.g., through the commerce engine 114) to any number of followers 106. The profit sharing module 224 may share a significant portion of the margin (e.g., ranging from 10%-35% of downloadable music margin, 50% on books and/or electronic media, 70% on apparels, etc.) with the admired party associated with the admired party module 104.

The reporting module 228 may notify the admired party of the portion of data and/or meta data associated with the portion of the profit payable to the admired party (e.g., the portion of the profit derived from the transaction initiated by the follower 106 through the commerce engine 114 of the mark language page of the admired party module 104).

The accounting module 230 may process (e.g., capture, store, track, records, monitor, analyze, etc.) data and/or meta data associated with wholesale (e.g., base, volume-based, etc.) prices of branded offerings (e.g., quoted by distributors 108 of the branded offerings), retail prices (e.g., of branded offerings on the mark-up language page of the admired party module 104 (e.g., at a premium of the wholesale price), revenue amounts and/or profit distributions to various parties (e.g., to the admired party module 104, the distributor 108, the partner 110 and/or the service provider module 102). The reporting module 228 and/or the accounting module 230 may provide the admired party with real time user statistics (e.g., number of transactions) and/or revenue accounting information (e.g., break-up of revenue) associated to an offering.

In one embodiment, the accounting module 230 may communicate with the commerce engine 114 of the admired party module 104 to process information associated with the virtual inventory of branded offerings (e.g., data and/or meta data associated with a user traffic, an interest, a market, a record and/or log of activity, a sales history, etc.).

FIG. 3 is an exploded view of an admired party module 104 of FIG. 1, having a commerce engine module 300 and a mark-up language page 310, according to one embodiment. The commerce engine module 300 may include a management module 304, an offering analyzer 306 and/or a setting module 308. The management module 304 may provide the admired party (e.g., associated with the admired party module 104) with an access to control (e.g., an ability to modify) the offering, the virtual inventory and/or aspects of the commerce engine 114 (e.g., illustrated in FIG. 1) of the mark-up language page 310 (e.g., a website, a blog site) generated by the admired party module 104, based on preferences of the admired party.

For example, the management module 304 may automatically populate the mark-up language page 310 (e.g., the website) of the admired party with at least one offering (e.g., the branded offering) representing a value of the admired party (e.g., a political value, a social value, a religious value, a personal value, etc.) when the admired party integrates the branded commerce engine (e.g., the commerce engine 114) in the mark-up language page 310. The admired party may also be able to customize the description of an offering (e.g., through simple text, thumbnail, etc.).

The offering analyzer 306 may process (e.g., compare, analyze, track, etc.) the virtual inventory of the commerce engine 114 (e.g., illustrated in FIG. 1) with data and/or meta data communicated by the setting module 308. For example, the offering analyzer 306 may communicate with the service provider module 102 to determine whether the virtual inventory (e.g., having branded offerings generated based on preferences of the admired party) matches the preferences (e.g., statically, temporally, periodically and/or dynamically) communicated by the admired party (e.g., through the enrollment module 200 of FIG. 2, the setting module 308 and/or the management module 304).

The setting module 308 may process (e.g., capture, track, store, analyze, record and/or monitor) settings associated with the preferences of the admired party (e.g., associated with the settings for the offerings of the virtual inventory and/or the commerce engine 114 of the mark-up language page 310). For example, the admired party may modify preferences and/or values he/she communicated with the enrollment module 200 of FIG. 2, and or may wish the commerce engine 114 to recognize consistent, predicted and/or a base set of future preferences, rules and/or values (e.g., associated with the admired party) through the setting module 308 of the commerce engine module 300. In one embodiment, a communication by the admired party through the setting module 308 may update the profile database 210 of FIG. 2.

FIG. 4 is a table view 400 of content referenced by the profile database 210 of FIG. 2, having a party name field 402, a party type field 404, a profile data field 406, an offering type field 408, a distributor field 410, a revenue field 412, a distributor cost field 414, and a split field 416, according to one embodiment. The party name field may display an identifier associated with the admired party (e.g., having an admired party module 104).

The party type field 404 may display a label indicating a nature of a charisma of the admired party that may be perceptible to a follower 106 in a context (e.g., a social context, a web presence context, a political context, etc.). The profile data field 406 may display identifiers referencing values (e.g., interests, causes, beliefs, hobbies, etc.) of the admired party. The offering type field 408 may display labels indicating the nature of the offerings (e.g., digital, physical, service) provided by the commerce engine 114 of FIG. 1 on the mark-up language page generated by the admired party module 104.

The distributor field 410 may display an identifier referencing the distributor (e.g., the distributor 108 illustrated in FIG. 1. The revenue field 412 may display a revenue (e.g., of the service provider module 102) generated by (e.g., derived from) the purchase of the offering by the follower 106 through the commerce engine 114 integrated into the mark-up language page of the admired party module 104.

The distributor cost field 414 may display a value associated with the wholesale price of the offering (e.g., the distributor's price and/or cost of services rendered to the service provider module 102 for the branded offer). The split field may display a distribution of a profit (e.g, the revenue referenced in the revenue field 412 less the distributor cost referenced in the distributor cost field 414) between the service provider module 102 and the admired party module 104.

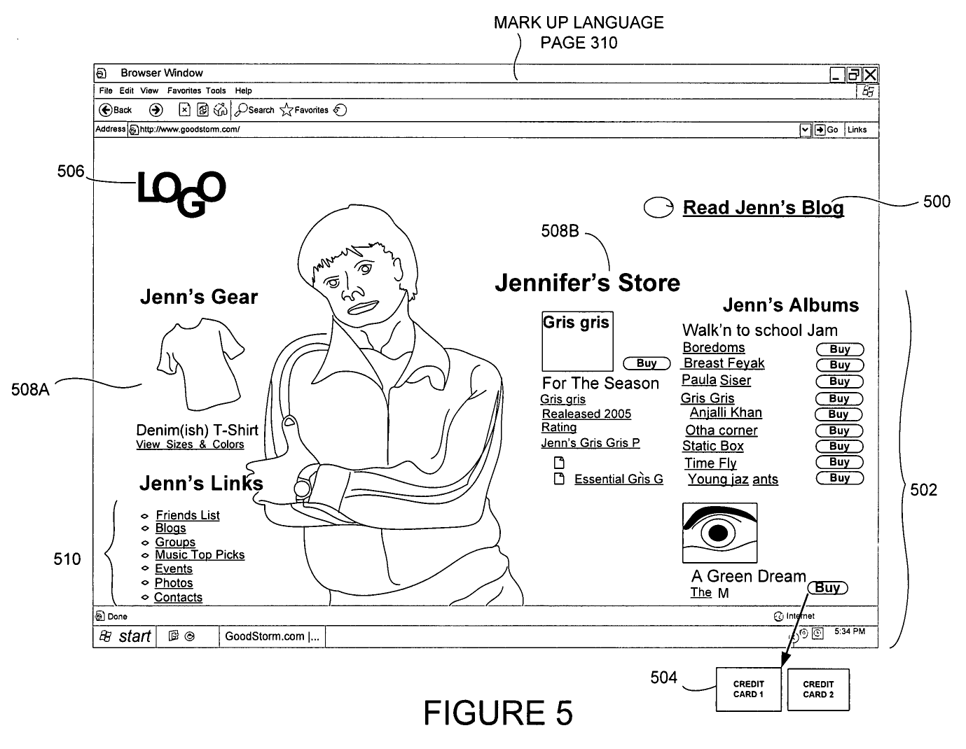

For example, two hypothetical admired parties of the profile database 210 are illustrated in FIG. 5. The party name field 402 displays “John Doe” and Mary Jane,” indicating the name of the admired parties. The party type field indicates “Blogger” and “Celebrity,” indicating that John Doe may have a charisma amongst followers 106 who may be readers of his blog, and that Mary Jane may have a social charisma amongst followers 106 based on her status as a celebrity.

The profile data field 406 displays “Tennis, Politics, Movies” and “Singer,” indicating that John may have values and/or interests including tennis, politics and/or movies, while Mary may be a celebrity singer. The offering type field 408 displays “service—U.S. Open tickets, Digital Media—Far Away DVDs” and “Physical—Autographed Posters, Digital—mp3 Audio,” indicating that John's virtual inventory of branded offerings (e.g., provided on John's blog through the commerce engine 114 illustrated in FIG. 1) includes services such as tickets to a prominent tennis tournament and/or media such as digital video discs of a motion picture (e.g., movie), and that Mary Jane's virtual inventory of branded offerings (e.g., provided on Mary Jane's website) includes physical offerings such as autographed posters of Mary Jane and/or digital media such as audio recordings of her music (e.g., in an mp3 format).

The distributor field 410 displays “U.S. Open, Vision Films” and “MaryJane, Inc., Solar Records,” indicating that the distributor associated with drop-shipping the offerings promoted on John's virtual inventory to followers 106 who purchase the offerings on John's blog site is “U.S. Open” for the tennis tournament tickets and “Vision Films” for the DVD movies, while the distributors associated with Mary Jane's virtual inventory are “MaryJane, Inc.” for the autographed posters and “Solar Records” for the audio recordings of her music.

The revenue field 412 displays “$500” and “$1000,” indicating that followers 106 of John's blog site have purchased $500 (e.g., have submitted a total of $500 in payment) of John's branded offerings, while followers 106 of Mary Jane's website have purchased $1000 of her branded offerings. The distributor cost field 414 displays “200” and “100,” indicating that the wholesale price (e.g., the price charged by the distributors 108 for providing and shipping the branded offerings ordered by the followers 106) for John's sales (e.g., the offerings purchased by followers 106 through the integrated branded commerce engine on John's blog site) is $100, while the wholesale price (e.g., the cost to the service provider module of the services rendered by the distributor 108) for Mary Jane's offerings is $100.

The split field 416 displays “AP: $200, SP: $100” and “AP: $700, SP: $200,” indicating that in the case of John, the portion of the profit ( e.g., the revenue less the distributor cost) from the transactions (e.g., from the payments processed of the followers 106 who purchased offerings through the admired party module 104 associated with John) that goes to John (e.g., the admired party, using the service provider module 102) is $200, while $100 goes to the service provider module 102. In the case of Mary Jane, the portion of the profit from the transactions through Mary Jane's website that goes to Mary (e.g., the admired party) is $700, while $200 goes to the service provider module 102.

FIG. 5 is a user interface view of the mark-up language page 310 of FIG. 3 associated with the admired party module 104 of FIG. 1, having a prompt view 500, a commerce engine view 502, an embedded payment processing view 504, a logo view 506, virtual inventory views 508A and 508B, and a links view 510, according to one embodiment.

The prompt view 500 may display a message customized to the admired party (e.g., “Jennifer,” based on information provided by Jennifer in a communication with the enrollment module 200 of FIG. 2). The prompt view 500 may alert the viewer (e.g., the follower 106) of the admired party (e.g., “Jennifer”) of other content associated with Jennifer (e.g., a blog site of Jennifer's). The commerce engine view 502 may display content associated with functions of the commerce engine 114 illustrated in FIG. 1 (e.g., may provide options for the follower 106 to view, compare, search, order and/or purchase, etc. branded offerings promoted by Jennifer).

The embedded payment processing view 504 is an example illustration of a function of the commerce engine (e.g., may not be visible to a viewer such as the follower 106). The commerce engine 114 illustrated in the commerce engine view 502 may reference an external payment verification authority (e.g., any number of credit card companies) to process and/or finalize a purchase transaction made by the follower 106 on Jennifer's mark-up language page (e.g., the mark-up language page 310).

The logo view 506 may display a textual and/or graphic visualization (e.g., may be designed by the admired party to be in alignment with a value of the admired party). The virtual inventory views 508A and 508B display a menu of branded offerings being promoted by the admired party (e.g., “Jennifer”). The virtual inventory may include selections, options to search the inventory, preferences, etc.

The service provider module 102 and Jennifer (e.g., the admired party associated with the user interface view illustrated in FIG. 5) may not physically stock any of the offerings promoted in the virtual inventory views (e.g., the offerings and/or items may be drop-shipped by a distributor 108 to the purchaser such as the follower 106 based on a the follower 106 completing an order through the commerce engine view 502).

The links view 510 may notify the viewer of other mark-up language pages that may be of interest to the viewer (e.g., the follower 106). For example, the other mark-up language pages may be associated with admired parties who are known to Jennifer (e.g., based on the follower 106 having an empathy and/or affinity for Jennifer based on a charismatic influence of hers). The follower 106 may be likely to want to visit websites and/or blogs (e.g., the mark-up language page 310) associated with admired parties who are known to Jennifer.

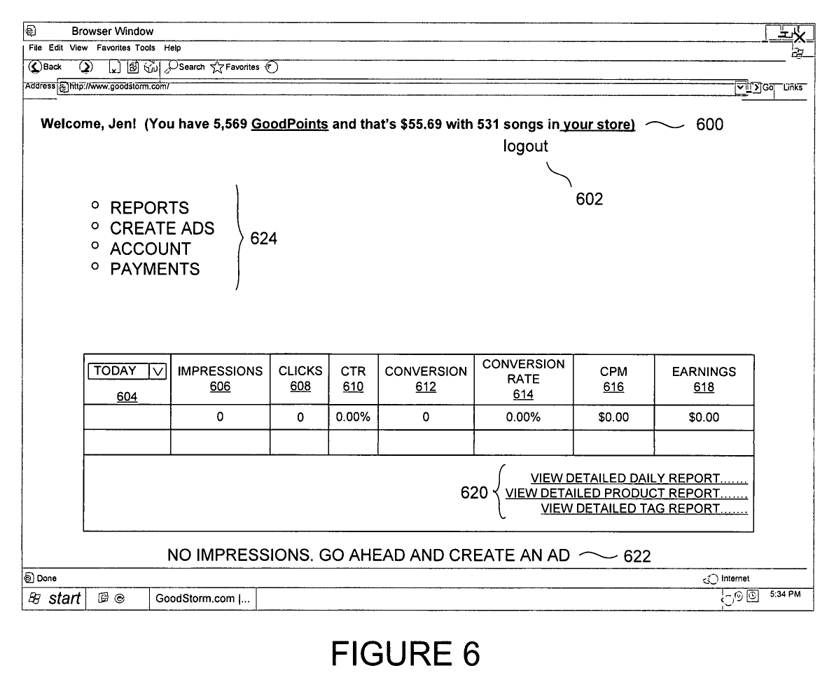

FIG. 6 is a user interface view of the service provider module of FIG. 1, having a welcome view 600, a logout view 602, a today view 604, an impressions view 606, a clicks view 608, a CTR (e.g., click-through rate) view 610, a conversion view 612, a conversion rate view 614, a CPM (e.g., cost per thousand impressions) view 616, an earnings view 618, a report view 620, a create ad view 622, and an options view 624, according to one embodiment.

The welcome view 600 may display a welcome message (e.g., to the admired party associated with the service provider module 102) based on information provided by the admired party (e.g., through a communication with the enrollment module 200 and/or the profile database 210 of FIG. 2). The welcome view may also include indicators of Jennifer's offerings, virtual inventory and/or account value (e.g., may display a point-based index value of the offerings in Jennifer's virtual inventory and/or account with the service provider module based on a communication with the profile database 210).

The logout view 602 may provide the admired party an option to exit the user interface view. The today view 604 may display data, meta data and/or statistical information associated with the date (e.g., the day, the calendar date) on which the admired party accesses the user interface view. For example, the today view 604 may notify the admired party of significant events (e.g., associated with the mark-up language page 310, the commerce engine 114 and/or the virtual inventory associated with the admired party) that occurred on the same day.

The impressions view 606 may display a value indicating a number of times an impression (e.g., a banner display, a pop-in, a link, etc.) is displayed of the offering in the admired party's virtual inventory (e.g., generated based on actions of the viewers). The clicks view 608 may display a value indicating a number of times viewers (e.g., the followers 106 of the admired party) may have clicked (e.g., with a mouse, with a touchpad, with a keyboard key, with a trackball, etc.) on various items (e.g., associated with the offerings) displayed on the mark-up language page 310 of the admired party (e.g., associated with the admired party module 104).

The CTR (e.g., click-through rate) view 610 may display a value indicating a ratio (e.g., a percentage, a metric, a decimal number, etc.) of the number of times the impression is displayed to the number of times the viewer clicks on the display (e.g., clicks through). The conversion rate view 614 may indicate a value expressing a number of conversions (e.g., successful transactions, requests for further information, etc.) relative to (e.g., as a fraction of) the number of viewers (e.g., the followers 106) that have visited the mark-up language page 310 (e.g., website) associated with the admired party.

The CPM (e.g., cost per thousand) view 616 may indicate a value for the cost (e.g., to the admired party, associated with the display of the impression for the offering) per every thousand impressions (e.g., displays of the offering generated by the viewers of the admired party's mark-up language page). The earnings view 618 may indicate a currency value of the total conversions (e.g., completed transactions, purchases, etc.) generated within a time frame. The report view 620 may provide the admired party with options (e.g., for visualizing, summarizing, expressing, recording, exporting and/or interpreting, etc.) the data, meta data and/or statistical information displayed and/or not displayed elsewhere in the user interface view.

The content displayed in the create ad view 622 may depend on certain value thresholds of the number of impressions indicated in the impressions view 606 (e.g., may prompt the admired party to create an advertisement and/or marketing effort to improve the number of impressions generated by viewers of the mark-up language page of the admired party (e.g., followers 106 of the admired party). The options view 624 may provide the admired party with options (e.g., choices) to access, extract, refer to, generate and/or reference, etc. various data, information, and/or meta data (e.g., the admired party's preferences, profile settings, reports for activity on the mark-up language page 310 of the admired party, financial options for the admired party, options for the admired party to modify content on the mark-up language page 310, settings for the commerce engine of the mark-up language page 310 associated with the admired party, etc.).

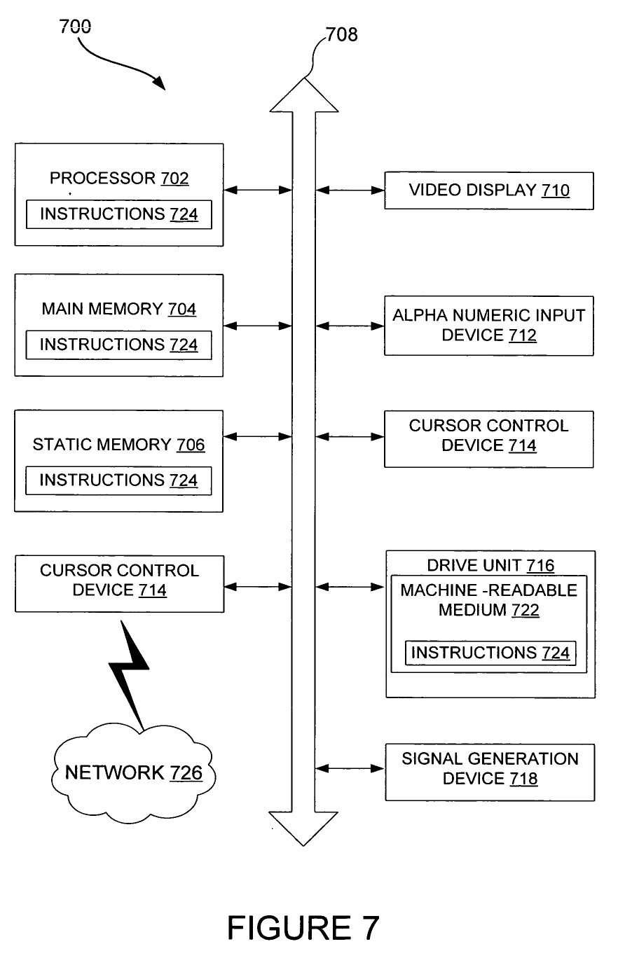

FIG. 7 is a diagrammatic representation of a data processing system 700 capable of processing a set of instructions to perform any one or more of the methodologies herein, according to one embodiment. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment.

The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 700 includes a processor 702 (e.g., a central processing unit (CPU) a graphics processing unit (GPU) and/or both), a main memory 704 and a static memory 706, which communicate with each other via a bus 708. The computer system 700 may further include a video display unit 710 (e.g., a liquid crystal display (LCD) and/or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies and/or functions described herein. The software 724 may also reside, completely and/or at least partially, within the main memory 704 and/or within the processor 702 during execution thereof by the computer system 700, the main memory 704 and the processor 702 also constituting machine-readable media.

The software 724 may further be transmitted and/or received over a network 726 via the network interface device 720. While the machine-readable medium 722 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

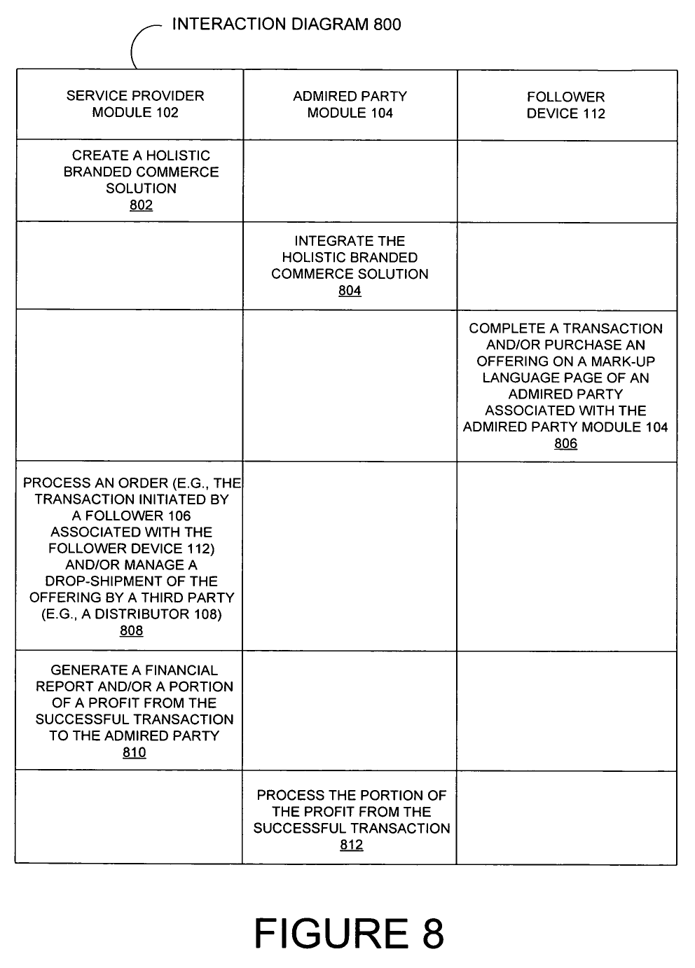

FIG. 8 is an interaction diagram of a process flow between the service provider module 102, the admired party module 104 and the follower device 112 of FIG. 1, according to one embodiment. In operation 802, the service provider module 102 creates a holistic branded commerce solution (e.g., for an admired party to monetize a charismatic influence an/or empathetic influence etc. Over a follower such as the follower 106 illustrated in FIG. 1 through a mark-up language page (e.g., website, blog, etc.). In operation 804, the admired party module 104 integrates (e.g., embeds) the holistic branded commerce solution (e.g., the commerce engine 114 of FIG. 1) into the mark-up language page (e.g., the mark-up language page 310 illustrated in FIG. 3) of the admired party. In operation 806, the follower device 112 (e.g., associated with the follower 106) completes (e.g., initiates and completes) a transaction and/or purchases an offering (e.g., an offering of a virtual inventory) on a mark-up language page (e.g., the mark-up language page 310) of an admired party associated with the admired party module 104. For example, the follower 106 may purchase the offering a price premium to a market price of a comparable offering, based on an empathy with a value of the admired party (e.g., a personal value, a political value, a religious value, a controversial value, etc.). In operation 808, the service provider module 102 processes an order (e.g., the transaction initiated by the follower 106 associated with the follower device 112), and/or manages (e.g., facilitates) a drop-shipment of the offering by a third party (e.g., a distributor 108). For example, the service provider module 102 and the admired party module 104 may not hold a physical inventory of the offerings on the mark-up language page 310. In operation 810, the service provider module 102 generates a financial report (e.g., using the reporting module 228 of FIG. 2) and/or a portion of a profit from the successful transaction (e.g., determined using the profit analyzer 226 and/or the profit sharing module 224 of FIG. 2) to the admired party. In operation 1012, the admired party module 104 (e.g., associated with the admired party of the mark-up language page 310) processes (e.g., receives) the portion of the profit from the successful transaction.

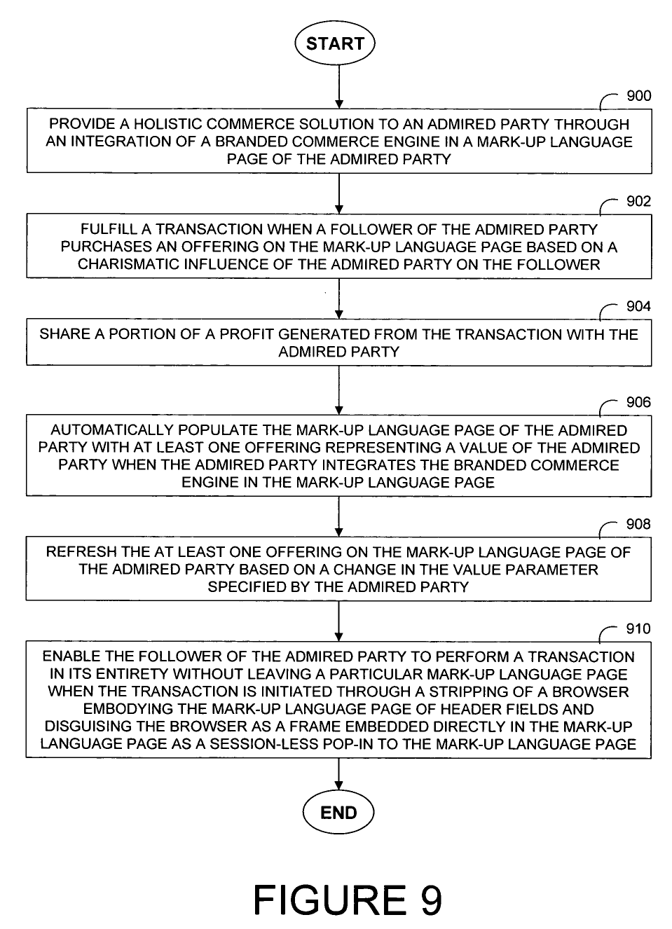

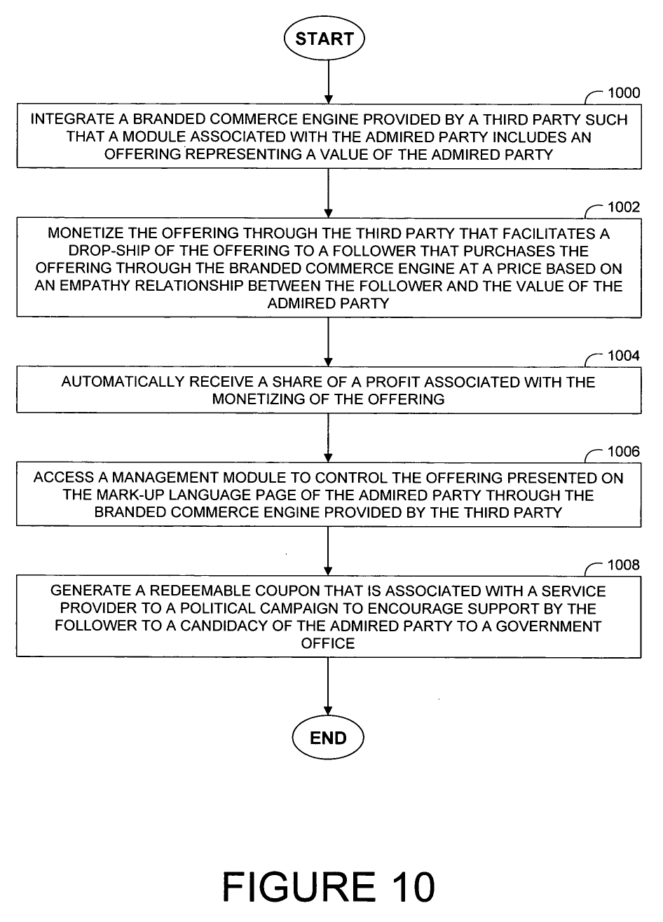

FIG. 9 is a process flow to provide a holistic commerce solution to an admired party, according to one embodiment. In operation 900, a holistic commerce solution is provided (e.g., by the service provider module 102 of FIG. 10 to an admired party (e.g., a celebrity, a blogger, a party having a social presence, a charismatic presence, a web presence, etc.) through an integration of a branded commerce engine (e.g., the commerce engine 114 illustrated in FIG. 1) in a mark-up language page (e.g., a website, a blog, the mark-up language page 310 illustrated in FIG. 3, etc.) of the admired party.

In operation 902, a transaction is fulfilled when a follower (e.g., the follower 106 illustrated in FIG. 1, having an empathy for, and/or appreciation for the admired party and/or values of the admired party) of the admired party purchases an offering (e.g., a digital media offering, a physical offering, a service etc.) on the mark-up language page 310 (e.g., from a virtual inventory provided on the mark-up language page 310) based on a charismatic influence of the admired party on the follower 106. In operation 904, a portion of a profit generated from the transaction is shared with the admired party (e.g., using the profit sharing module 224 of FIG. 2).

In operation 906, the mark-up language page 310 of the admired party is automatically populated with an offering representing a value of the admired party (e.g., may be determined through the enrollment module 200 and/or the profile database 210) when the admired party integrates the branded commerce engine in the mark-up language page 310. In operation 908, the offering on the mark-up language page 310 of the admired party is refreshed based on a change in the value parameter specified by the admired party (e.g., using the management module 304 of the commerce engine module 300 illustrated in FIG. 3).

In operation 910, the follower of the admired party (e.g., associated with the admired party module 104) is enabled to perform a transaction in its entirety without leaving a particular mark-up language page 310 when the transaction is initiated (e.g., using an i-frame technique, through a stripping of a browser embodying the mark-up language page of header fields and/or disguising the browser as a frame embedded directly in the mark-up language page as a session-less pop-in to the mark-up language page, etc.).

FIG. 10 is a process flow to integrate a branded commerce engine (e.g., the commerce engine 114 illustrated in FIG. 1) provided by a third party, according to one embodiment. In operation 1000, a branded commerce engine provided by a third party (e.g., the service provider module 102 illustrated in FIG. 1) is integrated such that a module associated with the admired party (e.g., the admired party module 104 illustrated in FIG. 1) includes an offering representing a value of the admired party (e.g., a political value, a religious value, a social value, a controversial value, a personal value etc.)

In operation 1002, the offering is monetized through the third party that facilitates a drop-ship of the offering (e.g., the distributor 108 illustrated in FIG. 1) to a follower (e.g., the follower 106 of FIG. 1) that purchases the offering through the branded commerce engine (e.g., the commerce engine 114) at a price based on an empathy relationship between the follower 106 and the value of the admired party (e.g., the price may be at a premium to a market value of the offering).

In operation 1004, a share of a profit associated with the monetizing of the offering is automatically received (e.g., by the service provider module 102 and/or the admired party module 104) in operation 1006, a management module (e.g., the management module 304 of FIG. 3) is accessed to control the offering presented on the mark-up language page 310 of the admired party through the branded commerce engine provided by the third party (e.g., the service provider module 102). In operation 1008, a redeemable coupon is generated that is associated with a service provider (e.g., of the service provider module 102) to a political campaign to encourage support by the follower 106 to a candidacy of the admired party to a government office.

Although the present embodiments have been described with reference to specific example embodiments, it will be evident that various modifications and changes may be made to these embodiments without departing from the broader spirit and scope of the various embodiments. For example, the various devices, modules, engines, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the service provider module 102, the admired party module 104, the follower device 112, the commerce engine 114, the enrollment module 200, the commerce engine generator module 202, the fulfillment module 204, the financial module 206, the customization module 212, the data analyzer 214, the virtual inventory module 216, the offering display module 218, the order processing module 220, the transaction module 222, the profit sharing module 224, the profit analyzer 226, the reporting module 228, the accounting module 230, the commerce engine module 300, the management module 304, the offering analyzer 306 and/or the setting module 308 may be enabled using transistors, logic gates, and electrical circuits (e.g., application specific integrated ASIC circuitry) using a service provider circuit, an admired party circuit, a follower circuit, a commerce engine, an enrollment circuit, a commerce engine circuit, a fulfillment circuit, a financial circuit, a customization circuit, a data circuit, a virtual inventory circuit, an offering display circuit, an order processing circuit, a transaction circuit, a profit sharing circuit, a profit circuit, a reporting circuit, an accounting circuit, a commerce engine circuit, a management circuit, an offering circuit and/or a setting circuit.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of a service provider comprising:
providing a holistic commerce solution to an admired party through an integration of a branded commerce engine in a mark-up language page of the admired party;
fulfilling a transaction when a follower of the admired party purchases an offering on the mark-up language page based on a charismatic influence of the admired party on the follower; and
sharing a portion of a profit generated from the transaction with the admired party.

2. The method of claim 1 wherein the admired party purchases the offering on the mark-up language page at a premium to a market value of the offering based on an empathy relationship between the follower and the admired party formed through the charismatic influence of the admired party on the follower.

3. The method of claim 1 further comprising automatically populating the mark-up language page of the admired party with at least one offering representing a value of the admired party when the admired party integrates the branded commerce engine in the mark-up language page.

4. The method of claim 3 wherein the at least one offering is determined from a virtual inventory based on a value parameter specified by the admired party and wherein the value parameter is based on at least one of a personal value, a political value, a religious value, a professional value, a social value and a controversial value.

5. The method of claim 4 further comprising refreshing the at least one offering on the mark-up language page of the admired party based on a change in the value parameter specified by the admired party.

6. The method of claim 1 further comprising enabling the follower of the admired party to perform a transaction in its entirety without leaving a particular mark-up language page when the transaction is initiated through a stripping a browser embodying the mark-up language page of header fields and disguising the browser as a frame embedded directly in the mark-up language page as a session-less pop-in to the mark-up language page.

7. The method of claim 1 wherein the fulfillment of the transaction is based on a drop-ship of the offering to the follower arranged through a network of distributors associated with the service provider when the follower purchases an offering on the mark-up language page of the admired party.

8. The method of claim 1 wherein the offering is at least one of a physical media, a digital media and a service.

9. The method of claim 1 in a form of a machine-readable medium embodying a set of instructions that, when executed by a machine, causes the machine to perform the method of claim 1.

10. A method of an admired party comprising:
integrating a branded commerce engine provided by a third party such that a module associated with the admired party includes an offering representing a value of the admired party;
monetizing the offering through the third party that facilitates a drop-ship of the offering to a follower that purchases the offering through the branded commerce engine at a price based on an empathy relationship between the follower and the value of the admired party; and
automatically receiving a share of a profit associated with the monetizing of the offering.

11. The method of claim 10 further comprising accessing a management module to control the offering presented on the mark-up language page of the admired party through the branded commerce engine provided by the third party.

12. The method of claim 11 further comprising generating a redeemable coupon that is associated with a service provider to a political campaign to encourage support by the follower to a candidacy of the admired party to a government office.

13. The method of claim 10 wherein the price associated with the monetizing the offering is at a premium to a market price of a comparable offering through a goodwill relationship formed between the follower and the admired party over a series of communications of the admired party made accessible to the follower through a web log structure.

14. A system comprising:
an admired party to integrate an adaptable commerce engine in a mark-up language page that monetizes a charisma of the admired party with a plurality of followers through a promotion of a branded offering on the mark-up language page;
a profit sharing module to allocate a portion of a profit to the admired party; and
a fulfillment module to conduct an end-to-end purchase to sale of the branded offering on behalf of the admired party.

15. The system of claim 14 wherein the admired party primarily provides a content-based information independent of monetizing a brand identity of the admired party, and wherein a growth of the brand identity is a result of a popularity of the content-based information in a geographic region.

16. The system of claim 14 wherein the profit sharing module provides a transparent financial visibility to the admired party of a wholesale purchase of the branded offering to the retail sale of the branded offering to the plurality of followers.

17. The system of claim 14 wherein the adaptable commerce engine is masked through a mark-up language technique such that an identity of an entity having the profit sharing module and the fulfillment module is not visible to the plurality of followers.

18. The system of claim 17 wherein the entity provides a service through a drop-ship from a distributor and wherein the entity stocks no inventory of the branded offering.

19. The system of claim 18 wherein an i-frame technique is used to mask an identity of the adaptable commerce engine, and wherein the adaptable commerce engine enables the admired party to customize a selection of the branded offering through a promotional selection tool associated with the entity.

20. The system of claim 17 wherein the branded offering is rotated along with other branded offerings on the mark-up language page, and wherein the branded offering is at least one of an apparel offering, a digital music offering, and a political message memorabilia offering.
